(19) United States
(12) Patent Application Publication
(10) Pub. No.: US 2001/0009467 A1
(43) Pub. Date: Jul. 26, 2001

(54) Dispersion compensation monitoring device and method, dispersion control apparatus and method, optical receiver, and optical transmission system

(76) Inventor: Sadao Fujita, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/768,314

(22) Filed: Jan. 25, 2001

(30) Foreign Application Priority Data
Jan. 26, 2000 (JP) 17451/2000

(51) Int. Cl. H04B 10/00

(52) U.S. Cl. 359/161; 359/173

(57) ABSTRACT

Disclosed is a dispersion compensation monitoring device that can be applied for an optical communication system for dispersion compensation, and that can simplify the device configuration and reduce the number of procedures.

According to the present invention, photo-electric conversion is performed by an optical front end for an optical signal obtained by dispersion compensation, and the output is amplified to a predetermined level by an automatic gain amplifier. One of the outputs of the amplifier is branched by a power divider, one of the branched outputs being detected thereafter by a power detector, while from the other output of the amplifier, a high frequency signal element is extracted by a high-pass filter and the strength of the signal is detected by another power detector. The outputs of the power detectors are transmitted to an identification circuit that determines the adequateness of a dispersion compensation value by dividing the outputs of the power detectors, comparing the results with the border values of the dispersion stress range, and defining the comparison result as a dispersion compensation value monitor output.

### BACKGROUND OF THE INVENTION

1. Field of the Invention

The present invention relates to a dispersion compensation monitoring device and method, a dispersion control apparatus and method, an optical receiver and an optical transmission system, and relates in particular to a dispersion compensation monitoring device and method for detecting, without a special measurement device being required, whether the dispersion compensation level along an optical fiber transmission path falls inside or outside a specified range, a dispersion control apparatus and method, an optical receiver, and an optical transmission system.

2. Related Arts

Generally, one of the characteristics of optical fiber used as an optical transmission path for an optical fiber communication system is that of wavelength dispersion. Specifically, the principle of the wavelength dispersion characteristic is that, depending on the wavelength, the time required for the transmission of optical signals differs. For a digital optical signal that is transmitted along optical fiber evidencing the wavelength dispersion characteristic, as the transmission speed (bit-rate) is increased, or as the optical fiber transmission distance is extended, following transmission deterioration of the waveform of the light occurs. The wavelength dispersion characteristic of an optical fiber in a typical single mode is wavelength dispersion value=18 ps/nm/km@wavelength 1.55 μm. Thus, when a digital signal is transmitted along an 80 km optical fiber at a transfer speed of 10 Gb/s, a pronounced effect is produced by the transmission characteristic, and due to the attendant wavelength dispersion, following the transmission the optical waveform is greatly distorted. As a result, marks and spaces in the received digital waveform can not be distinguished, so that optical transmission at a sufficiently low error rate and with high quality is disabled.

A method for compensating for the dispersion experienced with optical fiber, i.e., a method for inserting into optical fiber an optical device having a dispersion quantity that is equal in its absolute value to the dispersion quantity of the optical fiber but that has an inverted sign, has been discussed as means for compensating for the waveform distortion that is due to wavelength dispersion. FIG. 2 is a diagram showing the principle of a dispersion compensation device that is an optical device. In the example in FIG. 2, individual optical waveforms are transmitted at a speed of 10 Gb/s along the optical fiber which exhibits the wavelength dispersion characteristic. The vertical axis of the graph in FIG. 2 represents the total dispersion, and the horizontal axis represents the transmission length provided by the optical fiber.

In FIG. 2, the total dispersion increases as the transmission length is extended. Thereafter, the accumulated wavelength dispersion quantity is adjusted by the dispersion compensation device, which is installed in the optical receiver, so that the total dispersion value is zero. Generally, a dispersion compensation fiber (DCF) that provides a dispersion value having a sign that is the inversion of the sign of the transmission path, or a chirped fiber grating is employed as a dispersion compensation device. To provide dispersion compensation using this device, the dispersion value of the dispersion compensation device must match the total dispersion produced along the transmission path. If the dispersion compensation value at the optical receiver is smaller than the total dispersion produced along the transmission path, the equivalent waveform is shaped as in FIG. 2-1, where the pulse is expanded (under dispersion compensation).

When the dispersion compensation value is greater than the total dispersion produced along the transmission path, the equivalent waveform is shaped as in FIG. 2-3, where the pulse is compressed (over dispersion compensation). Since the equivalent waveforms in both cases are distorted, reception sensitivity is degraded. When the dispersion compensation value matches the total dispersion produced along the transmission path, the equivalent waveform is shaped the same as that transmitted by the optical receiver, and a preferable optical transmission path that produces no deterioration in sensitivity can be generated by the optical receiver. That is, for dispersion compensation it is important that the total dispersion produced along the transmission path must match the dispersion compensation value of the dispersion compensation device.

In order to equalize the total dispersion produced along a transmission path and the dispersion compensation value, first, the dispersion value along the transmission path must be precisely measured. Therefore, to date, dispersion measurements have been performed by using dispersion measurement devices. An example dispersion measurement device is a chromatic dispersion test system (HP86037) produced by Hewlett Packard Company. This measurement device comprises an optical pulse generator and a receiver. For this device, an optical transmitter and an optical receiver are installed at both ends of a transmission path (normally 40 to 80 km), and after synchronization of the transmitter and the receiver has been established, the dispersion occurring along the transmission path is measured. By using the measurement device to measure the dispersion value along a transmission path, an appropriate dispersion compensation value can be determined.

However, the prior art for which the above dispersion measurement device is used has the following shortcomings.

First, this dispersion measurement device is large and expensive. Since the dispersion measurement device is large, and since operators are required for the optical transmitter and the optical receiver, which are positioned far from each other, in order to use the dispersion measurement device to measure the dispersion occurring along a transmission path, an enormous amount of time and work are required of numerous operators, and facility costs, for the support of the operators and the maintenance and transportation of the measurement equipment, are very high.

### SUMMARY OF THE INVENTION

It is, therefore, one objective of the present invention to provide a dispersion compensation monitoring device and method whereby the size of the device is reduced and manufacturing costs are lowered, and fewer procedures are required to adjust a dispersion value along a transmission path, while using the dispersion control apparatus and method, and an optical receiver and an optical transmission system provided therefor.

To achieve the above objective, according to a first aspect of the invention, a dispersion compensation monitoring device comprises:

a first power detector for detecting the strength of an input digital signal;

a filter circuit for extracting, from the input digital signal, an element of a predetermined frequency band;

a second power detector for detecting the strength of a signal output by the filter circuit; and

a comparator for comparing a ratio of the outputs of the first and the second power detectors with a predetermined value.

It is preferable that the predetermined frequency band be a high frequency band.

The predetermined frequency band may be higher than a frequency corresponding to the bit rate of the input digital signal.

The dispersion compensation monitoring device may further comprise:

a rectifier for performing full-wave rectification of the output of the filter circuit.

Further, with the configuration, a low-pass filter may be provided for the input side of the first power detector.

According to a second aspect of the invention, a dispersion compensation monitoring device comprises:

a clock extraction circuit for extracting a clock signal from an input digital signal;

a multiplier for multiplying the input digital signal and the clock signal and outputting a product signal; and

a comparator for comparing the level of the product signal with a predetermined value.

With this configuration, the dispersion compensation monitoring device may further comprise:

a delay circuit, inserted between the clock extraction circuit and the multiplier, for delaying an input signal a predetermined period of time, and for subsequently outputting the input signal.

According to a third aspect of the invention, a dispersion control apparatus, for supplying control for a dispersion compensation value produced by a dispersion compensation device, comprises:

a dispersion compensation monitoring device having one of the above described configurations; and

a controller for converting a signal output by the comparator into a control signal that is asymptotic to the predetermined value, and for transmitting the control signal to the dispersion compensation device.

According to a fourth aspect of the invention, an optical receiver comprises:

a photodetector for converting into an electric signal an optical signal received along an optical transmission path; and

a dispersion compensation monitoring device, including one of the above described configurations, for receiving the electric signal as the input digital signal.

The first power detector may detect the strength of the input digital signal from the magnitude of a photocurrent that flows across the photodetector.

The optical receiver may further comprise:

a dispersion compensation device, inserted between the optical transmission path and the photodetector, for changing a dispersion value in accordance with a control signal that is externally received; and

a controller for converting a signal output by the comparator into the control signal that is asymptotic to the predetermined value, and for transmitting the control signal to the dispersion compensation device.

The dispersion compensation device may further comprise:

a first light switch for selectively connecting an input port, which is connected to the optical transmission path, to one of multiple output ports;

multiple dispersion compensation fibers, each of which has a different dispersion value, that are connected to the multiple output ports of the first light switch; and

a second light switch for selectively connecting to an output port one of multiple input ports, which are connected to output ends of the multiple dispersion compensation fibers.

According to a fifth aspect of the invention, an optical receiver comprises:

a photodetector for converting into an electric signal an optical signal received along an optical transmission path;

a first power detector for detecting the strength of the electric signal;

a filter circuit for extracting, from the electric signal, an element of a high frequency band;

a second power detector for detecting the strength of a signal output by the filter circuit;

a comparator for comparing a ratio of outputs of the first and the second power detectors with a predetermined value;

a rectifier for performing full-wave rectification of an output of the filter circuit;

a band-pass filter for extracting, from the output of the rectifier, a frequency element near the clock frequency of the electric signal; and

an identification/reproduction circuit for regarding the electric signal as a data entry and the clock signal as a clock entry in order to identify or reproduce the electric signal.

According to a sixth aspect of the invention, an optical receiver comprises:

a photodetector for converting into an electric signal an optical signal received along an optical transmission path;

a first power detector for detecting the strength of the electric signal in accordance with the magnitude of a photocurrent that flows across the photodetector;

a filter circuit for extracting, from the electric signal, an element of a high frequency band;

a second power detector for detecting the strength of a signal output by the filter circuit;

a comparator for comparing a ratio of outputs of the first and the second power detectors with a predetermined value;

a rectifier for performing full-wave rectification of an output of the filter circuit;

a band-pass filter for extracting, from the output of the rectifier, a frequency element near the clock frequency of the electric signal; and

an identification/reproduction circuit for regarding the electric signal as a data entry and the clock signal as a clock entry in order to identify or reproduce the electric signal.

According to a seventh aspect of the invention, an optical transmission system comprises:

an optical transmitter for transmitting an optical signal obtained by the modulation of a digital signal;

an optical transmission path along which the optical signal is transmitted; and

an optical receiver, having one of the above described configurations, for receiving the optical signal along the optical transmission path.

According to an eighth aspect of the invention, a dispersion compensation monitoring method comprises:

a first power detection step of detecting the strength of an input digital signal;

a filter step of extracting, from the input digital signal, an element of a predetermined frequency band;

a second power detection step of detecting the strength of an element extracted at the filter step; and

a comparison step of comparing, with a predetermined value, a ratio of the strengths detected at the first and the second power detection steps.

It is preferable that the predetermined frequency band be a high frequency band.

The predetermined frequency band may be higher than a frequency corresponding to the bit rate of the input digital signal.

The dispersion compensation monitoring method may further comprise:

a low-pass filter step, performed prior to the first power detection step, of extracting a low-pass frequency element from the input digital signal.

According to a ninth aspect of the invention, a dispersion compensation monitoring method comprises:

a clock extraction step of extracting a clock signal from an input digital signal;

a multiplication step of multiplying the input digital signal and the clock signal and of outputting a product signal; and

a comparison step of comparing the level of the product signal with a predetermined value.

With this configuration, the dispersion compensation monitoring method may further comprise:

a delay step, inserted between the clock extraction and the multiplication step, for delaying an input signal a predetermined period of time.

According to a tenth aspect of the invention, a dispersion control method, for controlling a dispersion compensation value produced by a dispersion compensation device, comprises:

a dispersion compensation monitoring method having one of the above described configurations; and

a control signal generation step of converting a signal output at the comparison step into a control signal that is asymptotic to the predetermined value, and of transmitting the control signal to the dispersion compensation device.

As is described above, according to the invention, the dispersion compensation monitoring device and method, the dispersion control apparatus and method, the optical receiver, and the optical transmission system include the first and the second power detectors (or the first and the second power detection steps) and the filter circuit (or the filter step) that are provided. Therefore, the state wherein the spectrum of a received signal is changed in accordance with the dispersion compensation value is detected, and thus, whether or not the dispersion compensation value is appropriate can be determined. Therefore, according to this invention, the appropriateness of the dispersion compensation value can be detected without using the dispersion measurement device that is conventionally required. Furthermore, when a conventional dispersion measurement device is used, the measurement units (the optical transmitter and the optical receiver) must be mounted on both the transmission and the reception ends of the optical transmission path, while with the present invention the measurement device need only be mounted on the reception end. As a result, it is expected that the present invention will contribute, especially for long distance optical communication systems, to the simplification of the required test arrangement and to a reduction in the measurement procedures that must be performed.

### BRIEF DESCRIPTION OF THE DRAWINGS

FIG. 1 is a diagram showing the configuration of an optical receiver according to a first embodiment of the present invention;

FIG. 2 is a diagram for explaining dispersion compensation;

FIG. 3 is a diagram showing output waveforms and signal spectra obtained by the dispersion compensation;

FIG. 4 is a diagram showing signal spectra obtained by dispersion compensation and spectra obtained by passing a signal through a virtual filter;

FIG. 5 is a diagram for explaining the principle of dispersion compensation;

FIG. 6 is a diagram showing the configuration of an optical receiver according to a second embodiment of the present invention;

FIG. 7 is a diagram showing the configuration of an optical receiver according to a third embodiment of the present invention;

FIG. 8 is a diagram showing the configuration of an optical receiver according to a fourth embodiment of the present invention;

FIG. 9 is a diagram showing the configuration of an optical receiver according to a fifth embodiment of the present invention;

FIG. 10 is a diagram showing the configuration of an optical receiver according to a sixth embodiment of the present invention;

FIG. 11 is a diagram showing the timing relationship between data and a clock transmitted to a multiplier; and

FIG. 12 is a diagram showing the arrangement of the multiplier according to the sixth embodiment of the present invention.

### DETAILED DESCRIPTION OF THE PREFERRED EMBODIMENTS

An explanation will now be given for the configurations and operations of a dispersion compensation monitoring device and method, a dispersion control apparatus and method, an optical receiver, and an optical transmission system according to the present invention.

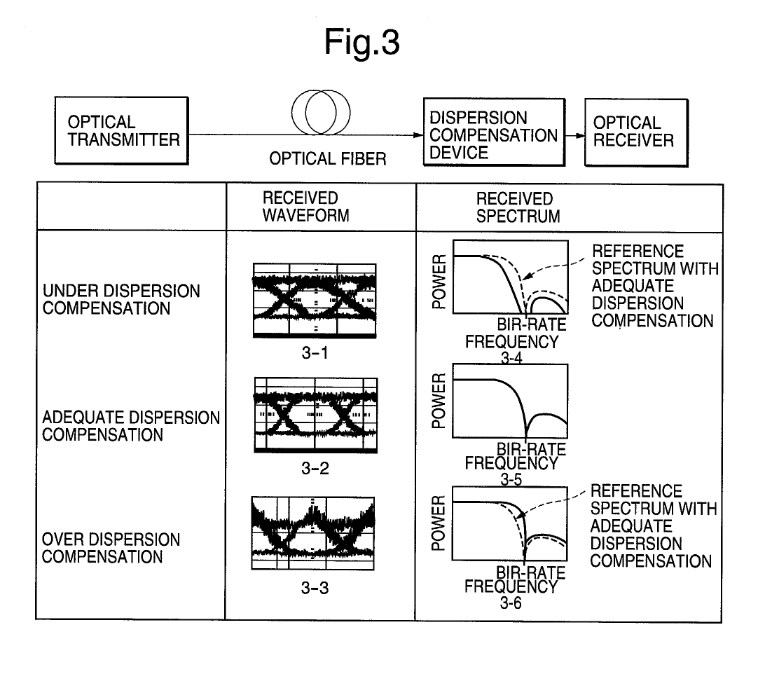

First, the operating principle of the invention will be described while referring to FIG. 3.

FIG. 3 is a diagram showing example received optical waveforms obtained by employing dispersion compensation, and received spectra corresponding to these waveforms. A waveform 3-2 is obtained by applying adequate dispersion compensation, and a spectrum 3-5 is obtained from its reception side. A waveform 3-1 is obtained by employing dispersion compensation, and a corresponding received spectrum 3-4 is shown. Pulse expansion occurs in the waveform 3-1; and in the received spectrum 304, spectrum at a high frequency is reduced when compared with the spectrum 3-5 obtained by employing adequate dispersion compensation. A waveform 3-3 is obtained by over dispersion compensation, and since pulse compression occurs, it appears that in a received spectrum 3-6 the high frequency spectrum is increased compared with the adequate spectrum.

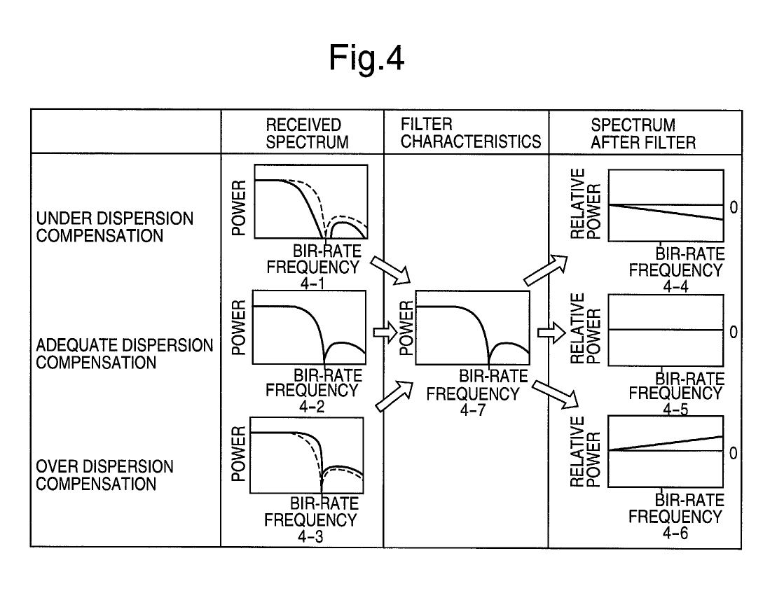

In FIG. 4, the above phenomena are shown along with more actual operations. A filter characteristic 4-7 in FIG. 4 is assumed to possess the same electric filter characteristic as does the spectrum of an adequate, received equivalent waveform. When the waveform 4-1, obtained by under dispersion compensation, the waveform 4-2, obtained by adequate dispersion compensation, and the waveform 4-3, obtained by over dispersion compensation, are fed to the filter, the relative output spectra are those identified by the numbers 4-4, 4-5 and 4-6. That is, when the dispersion compensation is insufficient, the high frequency spectrum is reduced compared with the low frequency spectrum, and when the dispersion compensation is excessive, the high frequency spectrum is increased compared with the low frequency spectrum. According to the invention, the adequateness of the dispersion compensation is monitored by detecting the relative value of the strength of the high frequency spectrum of the waveform provided by dispersion compensation.

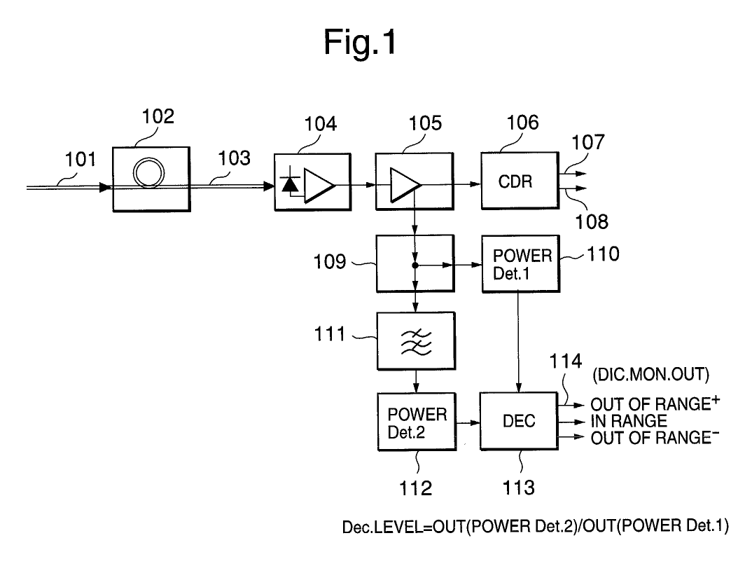

FIG. 1 is a block diagram illustrating an optical receiver according to a first embodiment of the present invention. In FIG. 1, the optical receiver comprises: a dispersion compensation device 102, an optical front end 104, an automatic gain amplifier 105, a clock/data reproduction circuit (CDR) 106, a power divider 109, a power detector 110, a high-pass filter 111, a power detector 112 and an identification device 113.

In FIG. 1, the dispersion compensation device 102 is connected to an input fiber 101 of a transmission path, and performs dispersion compensation for the optical fiber transmission path. An optical signal obtained by dispersion compensation is transmitted via an optical fiber 103 to the optical front end 104 that includes a PIN-PD and a preamplifier. The optical front end 104 performs photoelectric conversion for the optical signal, and transmits the resultant signal to the automatic gain amplifier 105. One of the outputs of the automatic gain amplifier 105 is transmitted to the clock/data reproduction circuit 106. The clock/data reproduction circuit 106 identifies, reproduces and outputs the data 107 and a clock 108. The other output of the automatic gain amplifier 105 is branched by the power divider 109, one output of which is detected by the first power detector 110. The other output is transmitted to the high-pass filter 111, which in turn extracts only the high frequency signal element, and the strength of the signal is detected by the second power detector 112. The outputs of the first and the second power detectors 110 and 112 are transmitted to the identification device 113 that determines the adequateness of the dispersion compensation. The identification device 113 compares the result obtained by dividing the outputs of the power detectors 110 and 112 (Dec-level= out(det.2)/out(det.1)) by the border value of the dispersion stress range, and regards the result as a dispersion compensation monitor output 114. In this embodiment, three monitor output terminals are connected to the respective LEDs of the optical receiver, and a corresponding LED is turned on in accordance with the production of an insufficient, adequate or excessive dispersion compensation value.

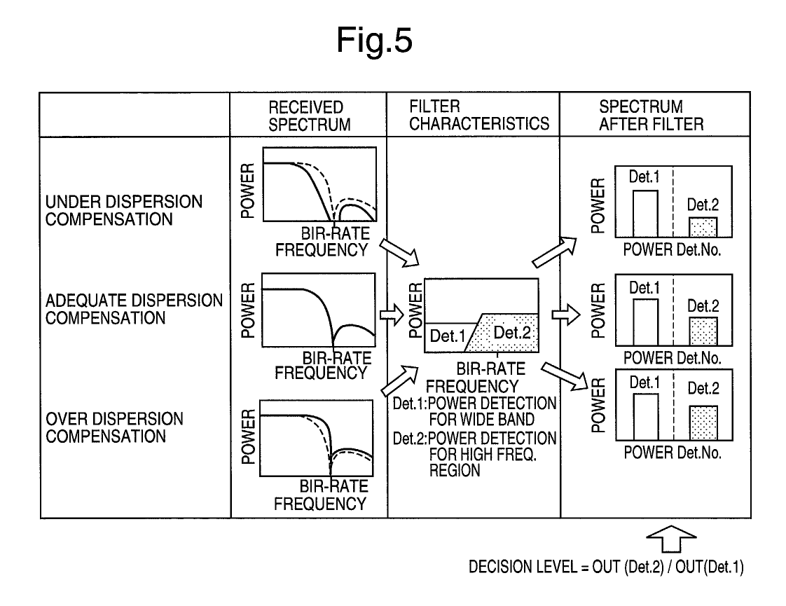

The principle of the operation of the dispersion compensation monitor in this embodiment will now be explained while referring to FIG. 5. In FIG. 5 are shown the spectra of the received waveforms when the dispersion value following the employment of dispersion compensation is insufficient, adequate or excessive; the bands detected by the first and the second power detectors; and the outputs of these detectors under the individual operating conditions. In this case, the output of the second power detector for detecting a high frequency element is increased in accordance with the insufficient, adequate or excessive dispersion compensation. In order to operate the optical receiver as a dispersion monitoring circuit, in accordance with the dispersion stress of the optical receiver, the threshold value need only be set for the identification levels lying between under dispersion compensation and adequate dispersion compensation and between adequate dispersion compensation and over dispersion compensation, and the results provided by the power detectors (Decision level=out(det2)/out(det1)) need only be compared with the threshold values.

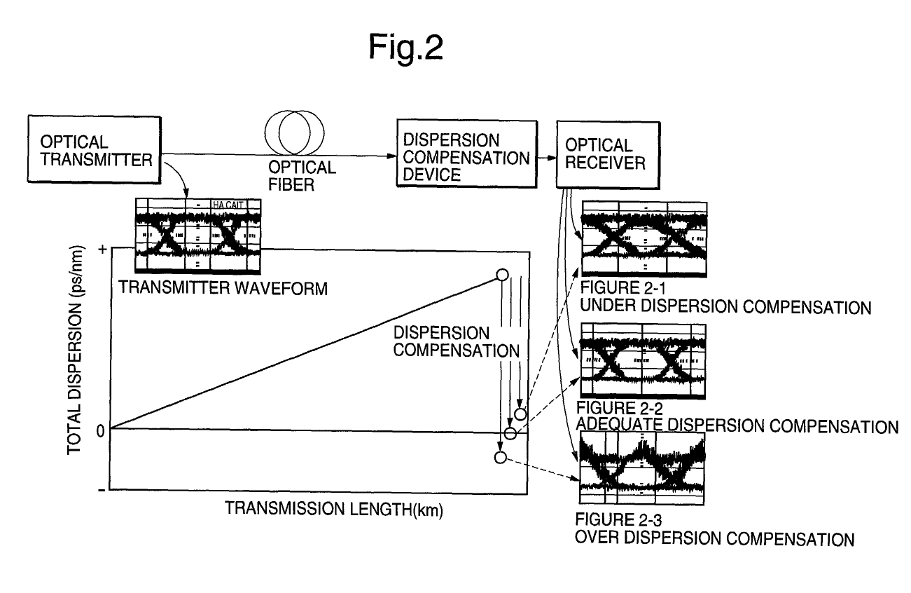

In this embodiment, assume that the optical transmission system is constituted by an optical transmitter and an optical receiver, which employs an external modulator for transmission at a transfer speed of 10 Gb/s. In this case, the configuration of the optical transmission system is that shown in the upper portion in FIG. 2 or 3. Further, assume that the dispersion of an optical fiber used as the optical transmission path is 18 ps/nm/km@1.55 μm, and that the length of the transmission path is 80 km. And that in addition, the cutoff frequency of the high-pass filter 111 in the optical receiver is set to 5 GHz, and the identification level for the dispersion compensation monitor is so set that, for a residual dispersion equal to or greater than +400 ps/nm, the output under dispersion compensation is provided and that, for a residual dispersion equal to or less than −400 ps/nm, the output over dispersion compensation is provided. Under these conditions, the dispersion value of the dispersion compensation fiber, which is the dispersion compensation device 102 in FIG. 1, was changed, and the operation of the dispersion compensation monitor circuit of this embodiment was examined. As a result, it was found that when the dispersion compensation fiber has a dispersion value of −1000 ps/nm (residual dispersion 440 ps/nm 80 km·18 ps/nm/km−1000 ps/nm), the monitor 114 outputs a signal indicating under dispersion compensation. That when the dispersion compensation fiber has a dispersion value of − 1500 ps/nm (residual dispersion=−80 ps/nm=80 km·18 ps/nm/km−1500 ps/nm), the monitor 114 outputs a signal indicating adequate dispersion compensation. And that when the dispersion compensation fiber has a dispersion value of −2000 ps/nm (residual dispersion=−560 ps/nm=80 km·18 ps/nm/km−2000 ps/nm), the monitor 114 outputs a signal indicating over dispersion compensation. Thus, when the present invention is employed, at the installation site only the dispersion value of the dispersion compensation device need be adjusted for the output of the dispersion compensation monitor circuit to fall within an ad equate range.

According to the present invention, since only the high-pass filter and the power detectors are added to the conventional optical receiver, adequate dispersion compensation for the optical transmission path can be easily provided without a special measurement device being required.

In this embodiment the high-pass filter sets, as the cutoff frequency, a frequency that is half the transfer speed of the signal; however, the cutoff frequency is not limited to this arrangement. That is, as is shown in FIG. 3, in a frequency range that is higher than the signal transfer speed, the shape of the spectrum is vertically changed depending on the adequateness of dispersion compensation. Therefore, even when only one part of the frequency range is extracted by the filter, the adequateness of the dispersion compensation can also be determined.

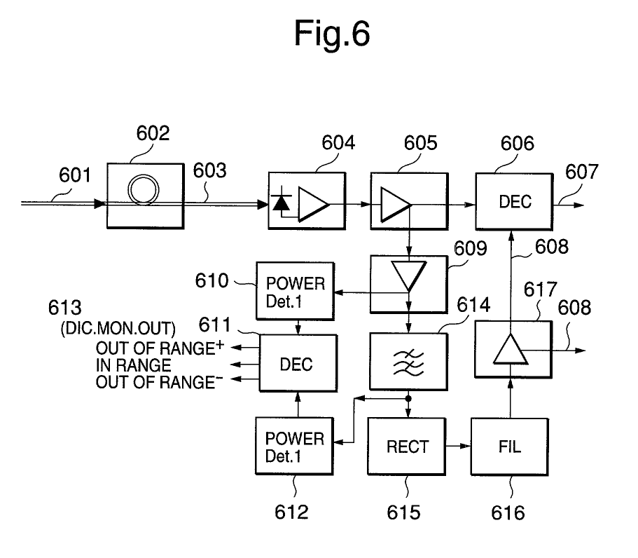

A second embodiment of the present invention will now be described while referring to FIG. 6.

In this embodiment, a high-pass filter 614, which performs a derivative action for an optical equalizing waveform, is employed as the clock reproduction circuit for the optical receiver. Since the high-pass filter 614 replaces the high-pass filter used for the first embodiment, the number of parts is reduced. In this embodiment, the clock reproduction circuit comprises: an equalizing differential amplifier 609, the high-pass filter 614, a full-wave rectifier 615, a band-pass filter 616, a limiter amplifier 617 and an identification circuit 606.

The equalizing differential amplifier 609 amplifies the received equalizing output. The high-pass filter 6145 controls the derivative action. The full-wave rectifier 615 performs a repetitive operation in order to extract a clock element from a differential waveform. The band-pass filter 616 extracts the clock element from the output of the full-wave rectifier 615 and transmits it to the limiter amplifier 617. The limiter amplifier 617 amplifies the clock element to provide a satisfactory amplitude that it outputs to the identification circuit 606, which employs a D flip-flop as its basic circuit. And the identification circuit 606 reproduces and outputs a data signal 607.

A first power detector 610, for detecting the full strength of the equalizing output, receives the output of the equalizing differential amplifier 609, and a second power detector 611, for detecting the strength of a high-frequency output derived from a received waveform, receives the output of the high-pass filter 614 that performs the derivative action. The operating principle of the dispersion compensation monitor circuit of this embodiment is the same as that of the first embodiment.

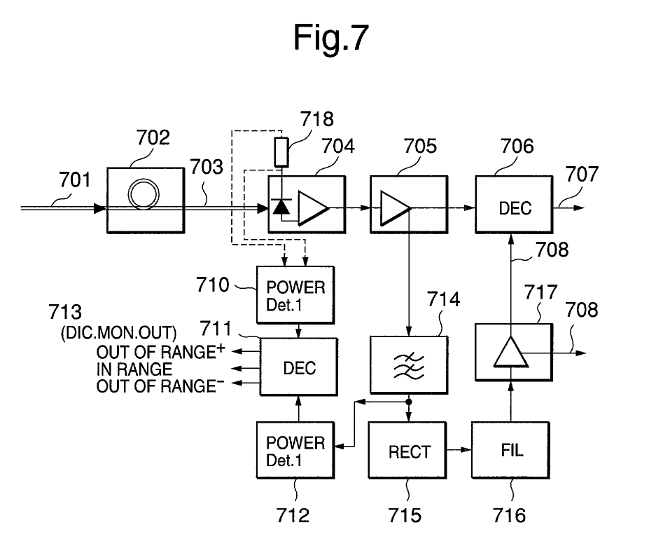

FIG. 7 is a diagram illustrating an optical receiver according to a third embodiment.

In this embodiment, the same clock reproduction circuit as is used in the second embodiment is provided, and a high-pass filter 714 is used in common by the clock reproduction circuit and the dispersion compensation monitor circuit. The difference between this and the second embodiment is that a first power detector 710, for detecting the full strength of the equalizing signal, receives signals from both ends of a resistor 718 that is connected in series to the PIN-PD included in the optical front end. When the configuration of this embodiment is employed, a dispersion compensation monitor circuit can be provided for which the minimum number of parts are required. Further, the arrangement used for the embodiment may be altered; an input optical signal may be branched in accordance with an optical level, and the output of a photodetector used for monitoring may be transmitted to the first power detector 701.

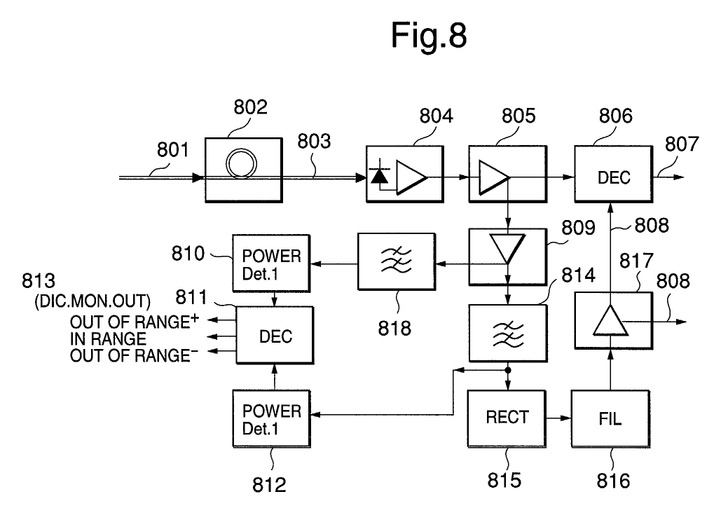

FIG. 8 is a diagram showing the configuration of an optical receiver according to a fourth embodiment of the present invention.

For this embodiment, the optical receiver used for the second embodiment is modified, and the identification precision of the dispersion compensation monitor circuit is improved. To accomplish this, a filter is inserted adjacent to the input side of the first power detector. That is, in this embodiment, the S/N ratio of a first power detector 810 is enhanced by inserting a low-pass filter 818 adjacent to the input side of the first power detector 810. Further, as another modification, the number of power detectors for the dispersion compensation monitor circuit may be increased from two to four, and filters for passing different frequencies may be inserted adjacent to the input sides of the respective power detectors, so that between equalizing waveforms obtained by the dispersion compensation the shapes of spectra may be more precisely compared.

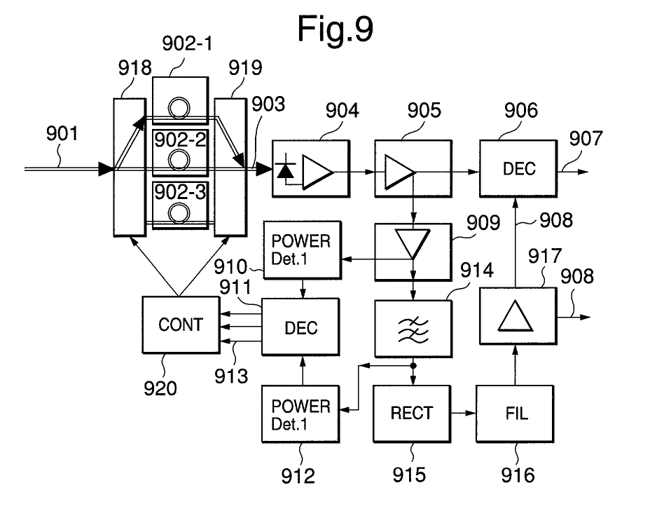

FIG. 9 is a diagram illustrating an optical receiver according to a fifth embodiment. The optical receiver in this embodiment is a modification of the second embodiment. The difference between this and the second embodiment is that a dispersion compensation device is provided wherein it is possible to switch from one to the other of the multiple dispersion compensation elements comprising the device. The dispersion compensation device in this embodiment comprises: a first light switch 918, which selectively connects its input port to one of multiple output ports; multiple dispersion compensation elements 902-1, 902-2 and 902-3, which are connected to the output ports of the first light switch 918; and a second light switch 919, which is connected at its input ports to the dispersion compensation elements 902-1, 902-2 and 902-3, and which selectively connects one of its input ports to its output port.

Further, in this embodiment, a controller 920 is connected to an output terminal 913, part of an identification circuit 911. The controller 920 controls the light switches 918 and 919, so that the output of the identification circuit 911 of the dispersion compensation monitor circuit always falls within an adequate dispersion compensation range. Specifically, when the output of the identification circuit 911 indicates over dispersion compensation, the controller 920 generates a control signal to select a dispersion compensation element having a smaller dispersion value, and transmits the control signal to the first and the second light switches 918 and 919. And when the output of the identification circuit 911 indicates under dispersion compensation, the controller 920 generates a control signal to select a dispersion compensation element having a greater dispersion value. While when the output of the identification circuit 911 indicates adequate dispersion compensation, no selection procedure is performed by the controller 920, and the operational use of the current dispersion compensation element is continued.

When dispersion compensation fibers (DCFs) having dispersion values of, for example, −800 ps/nm, −1600 ps/nm and −2400 ps/nm are employed as the dispersion compensation elements 902-1, 902-2 and 902-3, the dispersion compensation can be automatically implemented at a speed of 10 Gb/s along an optical fiber having a dispersion value of 18 ps/nm/km, and having an arbitrary transmission length of from 20 km to 160 km. In this embodiment, when the number of dispersion compensation devices 902 is increased, automatic dispersion equalization can also be implemented for transmission along a longer optical fiber.

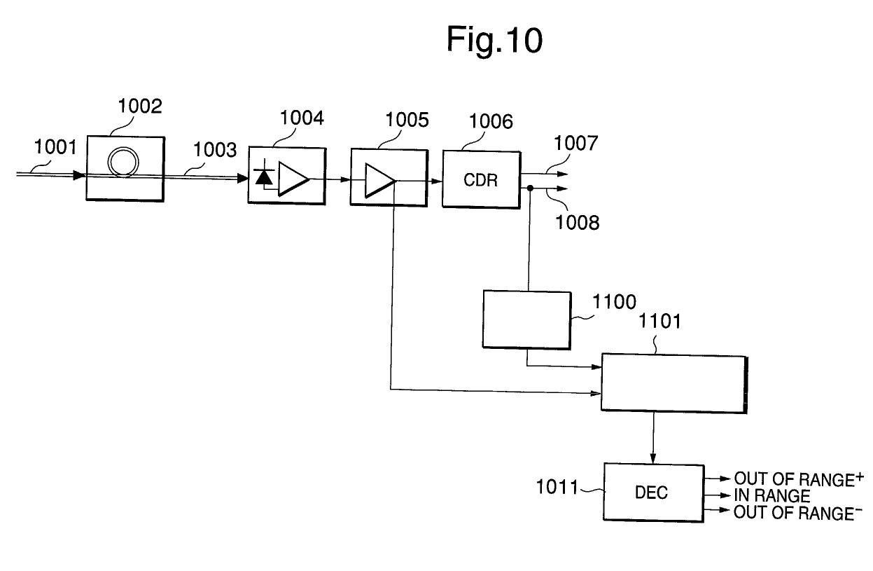

FIG. 10 is a diagram illustrating the configuration of an optical receiver according to a sixth embodiment of the present invention. In this embodiment unlike the above embodiments, the adequateness of the dispersion compensation is detected by using a signal level in a phase close to the center of each of the bits consisting of a received digital signal. That is, as is apparent from the waveforms of the received signals in FIG. 2, the signal level in the phase substantially in the center of a the marked bit is changed in accordance with the adequateness of the dispersion compensation. For under dispersion compensation, the signal level is reduced, and for over dispersion compensation, the signal level is increased.

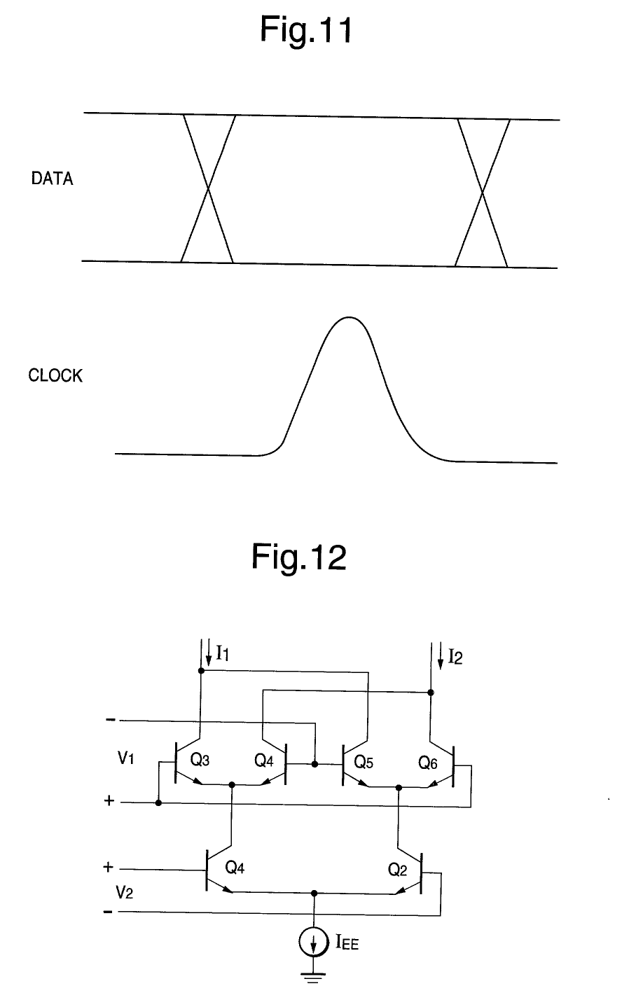

The optical receiver in FIG. 10 comprises: an optical front end 1004, a limiter amplifier 1005, a CDR 1006, a delay element 1100, a multiplier 1101 and an identification circuit 1013. The delay value of the delay element 1100 is determined so that the relationship shown in FIG. 11 is established for the phases of the clock and the data signal input to the multiplier 1101. FIG. 12 is a diagram showing the structure of the multiplier 1101 wherein a well known Gilbert-type multiplier is used. In FIG. 12, two differential signals are received from V1 and V2, and the multiplication output is provided as I1-I2.

The optical signal input to the optical receiver in this embodiment is converted into an electric signal by the optical front end 1004. Then, the electric signal is amplified to a predetermined level by the limiter amplifier 1005, and a clock signal is extracted by the CDR 1006. The extracted clock signal is thereafter transmitted, via the delay element 1100, to one of the input terminals of the multiplier 1101, while the output of the limiter amplifier 1005 is transmitted to the other input terminal of the multiplier 1101. The multiplier 1101 performs an analog mixer operation for the received signals, and outputs a signal as the product. Subsequently, the inverted output of the multiplier 1101 is transmitted to the identification circuit 1013, where it is compared with a predetermined threshold value to determine whether the dispersion compensation value is adequate, low or excessive.

As is described above, according to the present invention, merely by adding power detectors and a filter circuit to an optical receiver, the adequateness of dispersion compensation can be detected. Therefore, the provision of dispersion compensation for an optical fiber is enabled without the preparation of a special wavelength dispersion measurement device or the performance of a complicated dispersion measurement being required. Therefore, since the size of a dispersion compensation device can be reduced as can the operating costs for the installation and the employment of the optical transmission system, a reduction can be expected in the overall expenditures associated with the procurement and employment of the system.

What is claimed is:

1. A dispersion compensation monitoring device comprising:
a first power detector for detecting the strength of an input digital signal;
a filter circuit for extracting, from said input digital signal, an element of a predetermined frequency band;
a second power detector for detecting the strength of a signal output by said filter circuit; and
a comparator for comparing a ratio of the outputs of said first and said second power detectors with a predetermined value.

2. A dispersion compensation monitoring device according to claim 1, wherein said predetermined frequency band is a high frequency band.

3. A dispersion compensation monitoring device according to claim 1, wherein said predetermined frequency band is higher than a frequency corresponding to the bit rate of said input digital signal.

4. A dispersion compensation monitoring device according to claim 2, further comprising:
a rectifier for performing full-wave rectification of the output of said filter circuit.

5. A dispersion compensation monitoring device according to claim 1, wherein a low-pass filter is provided for the input side of said first power detector.

6. A dispersion compensation monitoring device comprising:
a clock extraction circuit for extracting a clock signal from an input digital signal;
a multiplier for multiplying said input digital signal and said clock signal and outputting a product signal; and
a comparator for comparing the level of said product signal with a predetermined value.

7. A dispersion compensation monitoring device according to claim 6, further comprising:
a delay circuit, inserted between said clock extraction circuit and said multiplier, for delaying an input signal a predetermined period of time, and for subsequently outputting said input signal.

8. A dispersion control apparatus, for controlling for a dispersion compensation value produced by a dispersion compensation device, comprising:
a dispersion compensation monitoring device having one of the above described configurations; and
a controller for converting a signal output by said comparator into a control signal that is asymptotic to said predetermined value, and for transmitting said control signal to said dispersion compensation device.

9. An optical receiver comprising:
a photodetector for converting into an electric signal an optical signal received along an optical transmission path; and
a dispersion compensation monitoring device, including one of the above described configurations, for receiving said electric signal as said input digital signal.

10. An optical receiver according to claim 9, wherein said first power detector detects the strength of said input digital signal from the magnitude of a photocurrent that flows across said photodetector.

11. An optical receiver according to claim 9, further comprising:
a dispersion compensation device, inserted between said optical transmission path and said photodetector, for changing a dispersion value in accordance with a control signal that is externally received; and
a controller for converting a signal output by said comparator into said control signal that is asymptotic to said predetermined value, and for transmitting said control signal to said dispersion compensation device.

12. An optical receiver according to claim 11, wherein said dispersion compensation device includes:
a first light switch for selectively connecting an input port, which is connected to said optical transmission path, to one of multiple output ports;
multiple dispersion compensation fibers, each of which has a different dispersion value, that are connected to said multiple output ports of said first light switch; and
a second light switch for selectively connecting to an output port one of multiple input ports, which are connected to output ends of said multiple dispersion compensation fibers.

13. An optical receiver comprising:
a photodetector for converting into an electric signal an optical signal received along an optical transmission path;
a first power detector for detecting the strength of said electric signal;
a filter circuit for extracting, from said electric signal, an element of a high frequency band;
a second power detector for detecting the strength of a signal output by said filter circuit;
a comparator for comparing a ratio of outputs of said first and said second power detectors with a predetermined value;
a rectifier for performing full-wave rectification of an output of said filter circuit;
a band-pass filter for extracting, from the output of said rectifier, a frequency element near the clock frequency of said electric signal; and
an identification/reproduction circuit for regarding said electric signal as a data entry and said clock signal as a clock entry in order to identify or reproduce said electric signal.

14. An optical receiver comprising:
a photodetector for converting into an electric signal an optical signal received along an optical transmission path;
a first power detector for detecting the strength of said electric signal in accordance with the magnitude of a photocurrent that flows across said photodetector;
a filter circuit for extracting, from said electric signal, an element of a high frequency band;
a second power detector for detecting the strength of a signal output by said filter circuit;
a comparator for comparing a ratio of outputs of said first and said second power detectors with a predetermined value;
a rectifier for performing full-wave rectification of an output of said filter circuit;
a band-pass filter for extracting, from the output of said rectifier, a frequency element near the clock frequency of said electric signal; and
an identification/reproduction circuit for regarding said electric signal as a data entry and said clock signal as a clock entry in order to identify or reproduce said electric signal.

15. An optical transmission system comprising:
an optical transmitter for transmitting an optical signal obtained by the modulation of a digital signal;
an optical transmission path along which said optical signal is transmitted; and
an optical receiver, according to one of claims 9 to 12, for receiving said optical signal along said optical transmission path.

16. A dispersion compensation monitoring method comprising:
a first power detection step of detecting the strength of an input digital signal;
a filter step of extracting, from said input digital signal, an element of a predetermined frequency band;
a second power detection step of detecting the strength of an element extracted at said filter step; and
a comparison step of comparing, with a predetermined value, a ratio of the strengths detected at said first and said second power detection steps.

17. A dispersion compensation monitoring method according to claim 16, wherein said predetermined frequency band is a high frequency band.

18. A dispersion compensation monitoring method according to claim 16, wherein said predetermined frequency band is higher than a frequency corresponding to the bit rate of said input digital signal.

19. A dispersion compensation monitoring method according to claim 16, further comprising:
a low-pass filter step, performed prior to said first power detection step, of extracting a low-pass frequency element from said input digital signal.

20. A dispersion compensation monitoring method comprising:
a clock extraction step of extracting a clock signal from an input digital signal;
a multiplication step of multiplying said input digital signal and said clock signal and of outputting a product signal; and
a comparison step of comparing the level of said product signal with a predetermined value.

21. A dispersion compensation monitoring method according to claim 20, further comprising:
a delay step, inserted between said clock extraction and said multiplication step, for delaying an input signal a predetermined period of time.

22. A dispersion control method, for controlling a dispersion compensation value produced by a dispersion compensation device, comprising:
a dispersion compensation monitoring method having one of the above described configurations; and
a control signal generation step of converting a signal output at said comparison step into a control signal that is asymptotic to said predetermined value, and of transmitting said control signal to said dispersion compensation device.
